(19) United States
(12) Patent Application Publication
(10) Pub. No.: US 2004/0257967 A1
(43) Pub. Date: Dec. 23, 2004

(54) Optical medium with double recording level

(76) Inventors: Bernard Bechevet, Claix (FR); Ludovic Poupinet, Seyssinet (FR); Alain Fargeix, Meylan (FR); Veronique Gehanno, Grenoble (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/492,198

(22) PCT Filed: Nov. 7, 2002
(86) PCT No.: PCT/FR02/03818

(30) Foreign Application Priority Data
Nov. 9, 2001 (FR) 01/14537

(51) Int. Cl. G11B 7/24

(52) U.S. Cl. 369/275.2; 369/288; 369/94

(57) ABSTRACT

The present invention relates to an optical medium, having on at least one face (10), a superficial recording level (20) and a buried recording level (30), capable of being read and recorded by means of an optical beam having a wave length between 620 and 670 nanometers, and wherein each of the levels has a reflectivity between 6% and 12%.

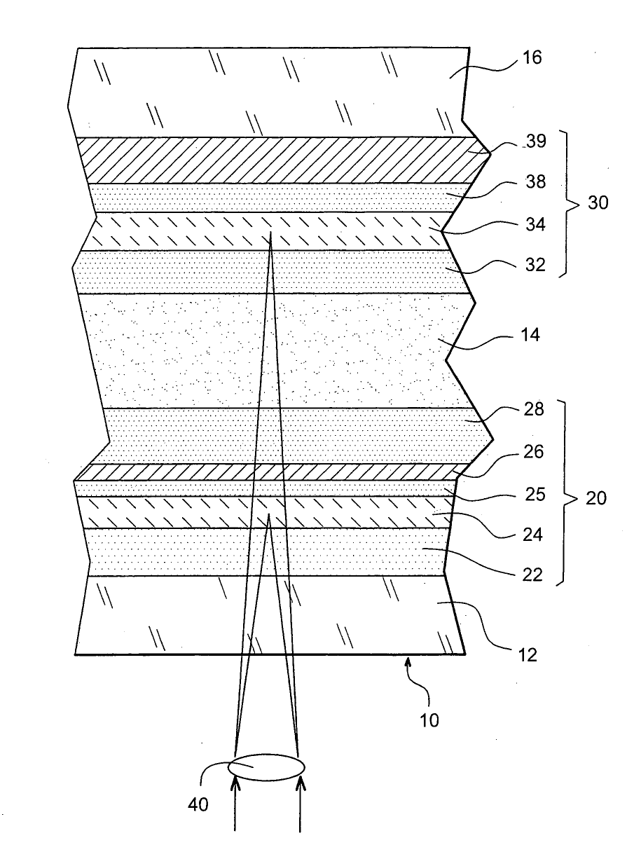

### TECHNICAL FIELD

The present invention relates to an optical recordable dual level recording medium. By dual level recording medium is meant a medium that has on at least one face, two levels, or two superimposed recording areas. To distinguish between them, the superimposed levels are said to be “superficial” and “buried”. A dual level optical disk may be of the single face or dual face type. In the latter case, each face of the disk may be dual level, with a total number of recording levels equal to four.

The invention finds applications in the recording of audio, video or computer data.

### STATE OF THE PRIOR ART

Writable and even rewritable DVD format optical disks are known.

These disks include on one or both of their faces a single recording level provided with a phase change material layer. For example, this is a layer of crystalline material capable of being made locally amorphous under the action of a writing beam. By modulating the writing beam according to a digital signal, a succession of amorphous material areas and crystalline material areas may be formed in the phase change layer. The succession of areas corresponds to the signal coding which is thereby written into the material. Material phase transitions are caused by local heating of the layer under the effect of the writing beam. Heating to a temperature allowing re-crystallization of the phase change layer may be applied for possible deletion of recorded data.

The subsequent read-out of the recorded signal occurs by scanning a succession of areas on the recording level. Read-out requires different reflectivity properties of the material in its amorphous phase and in its crystalline phase. Scanning is carried out by a read-out beam focused on the level, and is combined with a measurement of the intensity of reflected light.

The read and write units allowing the disks to be recorded are provided with a laser diode providing the writing beam. This is a diode emitting a beam of red light, the wavelength of which is close to 650 nm.

The stacking of two recording levels in a disk has been contemplated for increasing the storage capacity of these disks. On this subject, documents (1) to (9) may be referred to, the references of which are specified at the end of the present description. In particular, documents (8) and (9) concern reversible recording techniques.

Dual level disks have recording problems and to a lesser extent read-out problems. These problems come from the fact that the limited transparence of the superficial level is an obstacle for accessing the buried level.

Another problem is due to the fact that cooling the phase change layer too slowly may cause uncontrolled crystallization of an area which should be amorphous.

A new problem occurs in the sense that, by selecting a recording wavelength different from the usually retained wavelength, the dual level recording disks may be made incompatible with the present read-out and recording units. The effects of this incompatibility are particularly bothersome for units intended for the general public.

### DISCLOSURE OF THE INVENTION

The object of the invention is to provide a recording medium, and in particular a disk, of the dual level type, which does not have the limitations shown above.

One object is in particular to provide a medium compatible with the writing and reading wavelength of existing units.

One object is again to provide a medium providing fast and reliable recording, benefiting from good continuity.

To achieve these objects, the invention more specifically provides an optical medium having on at least one face, a superficial recording level and a buried recording level, capable of being read and recorded by means of an optical beam having a wavelength between 620 and 670 nanometers, and wherein each of the levels has a reflectivity between 6% and 12%.

The inventors have actually discovered that it was possible to carry out writing and reading of data on a dual level medium with existing units, for which the wavelength is of the order of 650 nm. With the reflectivity ranges indicated above, it is actually possible to record and read media with a power less than 22 mW.

Each recording level includes one or more phase change material layers. This may be a material such as GeSbTe, AgInSbTe or InSbTe type chalcogenides, as well as tellurium oxides or selenides. These materials have phase change properties between an amorphous state and a crystalline state with different reflectivities.

The phase change material may also be a material of the magneto-optical type. The phase change is then expressed by a change in the rotational property of the polarization of a light beam through the Kerr or Faraday effect.

Preferably, the material is selected with reversible phase change properties so as to allow rewriting.

Preferably, the phase change material layers are inserted between layers of dielectric materials such as ZnS—SiO₂ or AlN or even Si₃N₄. The latter contribute to adjusting the reflectivity values.

According to a particular example, the dielectric material is ZnS—SiO₂ (80%-20%) and the phase change material is Ge₂Sb₂Te₅.

An optical simulation achieved from the Abeles formalism, enables the thickness parameters of the different material layers used to be established. The calculation of these parameters takes into account the optical indexes n and k of the dielectric materials and of the phase change materials as well as those of possible optical reflectors and of thermal or mechanical backings associated with these layers.

According to an advantageous embodiment of the recording levels, the phase change layers may actually be associated with heat sinks. Heat sinks guarantee faster cooling of the phase change layers and prevent parasitic crystallization.

Other features and advantages of the invention will become apparent from the following description with reference to the FIGURE of the appended drawing. This description is given as a pure illustration and in a non-limiting way.

### DETAILED DESCRIPTION OF PARTICULAR EMBODIMENTS OF THE INVENTION

The appended single FIGURE is a schematically sectional view of a portion of an optical disk according to the invention, which may be used as a recording medium. For the sake of clarity, it should be specified that the different portions of the FIGURE are not illustrated according to a uniform scale.

The disk of the FIGURE comprises in this order from a read-out face 10, a first medium substrate 12, a first recording level 20, a transparent intermediate layer of adhesive 14, a second recording level 30 and a second medium substrate 16. The medium substrates are customary polycarbonate substrates used for manufacturing optical disks. They may be replaced with any other material, with the proviso that the first substrate remains transparent to a writing and read-out beam.

The optical disk may have two other recording levels, not illustrated in the FIGURE, which may then be accessible through another face, opposite the first face 10. The disk of the FIGURE is a dual level disk but with a single face.

The first recording level 20 again designated by “superficial level” comprises in this order from the first substrate 12, a first dielectric layer 22 of ZnS—SiO₂, a phase change Ge₂Sb₂Te₅ layer 24, a thermal resistance ZnS—SiO₂ layer 25, a heat sink layer 26 of ITO (indium-tin oxide) for example, and a second dielectric ZnS—SiO₂ layer 28.

The heat resistance and heat sink layers are not absolutely necessary. However they provide fast cooling of the phase change layer when the latter has undergone heating by a writing beam. In the case of an amorphous transition layer, i.e. a crystalline layer which is made locally amorphous for writing data, with fast cooling, it is possible to avoid any parasitic uncontrolled recrystallization.

As indicated earlier, the phase change layer materials and the dielectric layers may be replaced with other materials having phase change or dielectric properties. However the materials for the first level are selected in their composition or their thickness so as to let through a portion of the light which is applied to them. The superficial recording level is considered to be semitransparent.

The buried recording level substantially comprises the same layers. In the illustrated example, it comprises a first dielectric ZnS—SiO₂ layer 32, a phase change Ge₂Sb₂Te₅ layer 34, a second dielectric ZnS—SiO₂ layer 38, and a reflector layer 39. The reflectivity at the buried recording level may be increased with the reflector layer. This is an aluminum layer for example, which may also be used as a heat sink. As this is a buried level, the reflector layer 39 may be opaque.

According to the invention, the recording levels 20 and 30 each have a reflectivity between 8% and 12%. The reflectivity may be adjusted by adapting the optical indexes of the layers and/or their thickness.

By way of illustration, for a crystallized phase change material, having optical indexes such as n=3.8 and k=4, a dielectric material with n=2.05 and k=0, polycarbonate such as n=1.5 and k=0, the thicknesses of the layers are computed.

In the particular example considered here, the dielectric layers and the phase change material layers have for the superficial level and the buried level respectively, in the order from the surface, the following thicknesses:

D1s (22)=100 nm+/−10 nm,

CPs (24)=7 nm+/−0.5 nm,

D2s (28)=100 nm+/−10 nm,

D1e (32)=120 nm+/−10 nm,

CPe (34)=17.5 nm+/−3 nm,

D2e (38)=120 nm+/−10 nm.

With the values indicated above, a reflectivity of 10% is obtained. It is specified that the aluminum layer 39 in this example, has a thickness of 120 nm and that the adhesive layer has a thickness of 50 μm to within +/−5 μm.

The writing powers PW and the deleting powers Pe are Pw=19 mW and Pe=10 mW for the buried level and Pw=12 mW and Pe=6 mW for the superficial level, respectively. A read-out signal to noise ratio of the order of 48 and 50 dB is obtained for the superficial and buried levels.

According to another example, optimized for reflectivities of 8%, the following thicknesses are obtained, always with the same materials:

D1s (22)=80 nm+/−8 nm,

CPs (24)=7 nm+/−0.5 nm,

D2s (28)=100 nm+/−10 nm,

D1e (32)=1,000 nm+/−10 nm,

CPe (34)=17.5 nm+/−3 nm,

D2e (38)=40 nm+/−5 nm.

In this second example, the reflecting layer 39 is an aluminum layer with a thickness of 100 nm and the adhesive layer always has a thickness of the order of 50 μm+/−s μm.

The disk of the FIGURE may be obtained by successively depositing the layers of the first and second recording levels 20, 30 on substrates 12 and 16, respectively. The substrates provided with layers of the recording levels 20, 30 are then assembled via the adhesive layer 14.

Reference symbol 40 refers to a focusing lens of a read-out and writing device. So the latter is not a part of the recording medium. With the lens, a writing beam (or a deleting beam) or a read-out beam may selectively be focused on one of the phase change layers of one of the recording levels.

Mentioned Documents

1) U.S. Pat. No. 6,030,678;

2) U.S. Pat. No. 5,993,930;

3) U.S. Pat. No. 5,828,648;

4) U.S. Pat. No. 4,090,031;

5) U.S. Pat. No. 4,219,704;

6) U.S. Pat. No. 3,946,367;

7) U.S. Pat. No. 4,450,553;

8) U.S. Pat. No. 4,905,215;

9) U.S. Pat. No. 6,143,426.

1. An optical medium having on at least one face (10), a superficial recording level (20) and a buried recording level (30), capable of being read and recorded by means of an optical beam having a wavelength between 620 and 670 nanometers and wherein each of the levels has a reflectivity between 6% and 12%.

2. The medium according to claim 1, wherein each level comprises a phase change material layer (24, 34) inserted between dielectric material layers (22, 28, 32, and 38).

3. The medium according to claim 2, wherein the dielectric material is ZnS—SiO₂ and the phase change material is Ge₂Sb₂Te₅.

4. The medium according to claim 3, wherein the dielectric layers (D1s, D2s, D1e, D2e) and the phase change material layers (CPs, CPe) have for the superficial recording level and the buried recording level respectively, in the order from the surface, the following thicknesses:
D1s=100 nm+/−10 nm,
CPs=7 nm+/−0.5 nm,
D2s=100 nm+/−10 nm,
D1e=120 nm+/−10 nm,
CPe=17.5 nm+/−3 nm,
D2e=120 nm+/−10 nm.

5. The medium according to claim 4, wherein the dielectric layers (D1s, D2s, D1e, D2e) and the phase change material layers (CPs, CPe) have for the superficial level and the buried level, respectively, in the order from the surface, the following thicknesses:
D1s=80 nm+/−8 nm,
CPs=7 nm+/−0.5 nm,
D2s=100 nm+/−10 nm,
D1e=1,000 nm+/−10 nm,
CPe=17.5 nm+/−3 nm,
D2e=40 nm+/−4 nm.

6. The medium according to claim 1, wherein each recording level comprises a phase change material layer (24, 34) of the amorphous transition type, associated with at least one layer (26, 39) forming a heat sink.

7. The medium according to claim 6, wherein the buried level comprises a metal layer (39) forming a reflector and a heat sink.
